(19) United States
(12) Patent Application Publication
(10) Pub. No.: US 2003/0030911 A1
(43) Pub. Date: Feb. 13, 2003

(54) Flight crew emergency vision system

(76) Inventor: Michael H. Brooks, Los Angeles, CA (US)

Correspondence Address: Howard R. Popper, Ste #35, 4436 E. Camelback Rd., Phoenix, AZ, 85018-2833, US

(21) Appl. No.: 09/928,545

(22) Filed: Aug. 13, 2001

(51) Int. Cl. G02B 27/14

(52) U.S. Cl. 359/630

(57) ABSTRACT

An emergency oxygen mask, which conventional procedure will cause to be donned at the first sign of smoke, is provided with an eye protecting face plate for viewing a heads up display of flight data critical for safely maneuvering the aircraft. When the oxygen supply is started, the heads up display is activated, for example by the pilot pressing a maximum O₂ flow valve. Video data from an interface to the aircraft's ARINC 429 data bus is sent to the heads up display to provide the pilot with aircraft attitude, (pitch and bank), altitude, and heading so that the aircraft can be controlled and emergency procedures can be conducted.

### FIELD OF THE INVENTION

This invention relates to cockpit information display systems and, more particularly to an emergency flight data display apparatus.

### BACKGROUND OF THE INVENTION

Smoke in the cockpit has been responsible for a number of aircraft accidents in which the smoke obscured critical flight reference data, prevented the flight crew from properly operating the aircraft and resulted in the loss of lives. Because of the confined conditions of the cockpit, even a minor fire producing minimal smoke can rapidly render cockpit instrument panels unreadable. Current procedures call for the flight crew to don oxygen masks at the first sign of smoke in the cockpit. However, the conventional oxygen mask functions only as a breathing apparatus for use in the absence of breathable air but offers no protection for the eyes air against blinding smoke. Although the conventional oxygen mask allows the crew to continue to breath, that may be of little benefit as the plane may crash if the pilot can not see the instrument panel to learn the aircraft's speed, attitude, heading and altitude and maneuver the aircraft to a safe landing.

### SUMMARY OF THE INVENTION

In accordance with the principles of the present invention, an emergency oxygen mask, which conventional procedure will cause to be donned at the first sign of smoke, is provided with an eye protecting face plate for viewing a heads up display of flight data critical for safely maneuvering the aircraft. When the oxygen supply is started, the heads up display is activated, for example by the pilot pressing a maximum O₂ flow valve. Video data from an interface to the aircraft's ARINC 429 data bus is sent to the heads up display of the emergency oxygen mask to provide the pilot with aircraft attitude, (pitch and bank), altitude, and heading so that the aircraft can be controlled and emergency procedures can be conducted. Two embodiments are disclosed. In a first embodiment, video data is projected on the inside of the mask faceplate from a projector mounted within the mask. In a second embodiment, the mask is provided with a liquid crystal display fold-down panel which can be viewed through the eye-protecting faceplate. Both the projector and the fold-down display receive video data from a new data processing input/output unit (DPIO) which provides an interface either to the existing aircraft ARINC data bus system or to an alternative installed data source, such as the Goodrich Aerospace GH-3000 ESIS system.

### BRIEF DESCRIPTION OF THE DRAWING

The foregoing and other objects and features of the present invention may become more apparent when the ensuing description is read together with the drawing in which:

FIG. 1 shows the emergency heads up display system of the invention;

FIG. 2 is a block diagram of the system data processing input/output (DPIO) unit for driving the heads up display;

FIG. 3 is a view of the full face oxygen mask and face plate on which the critical flight data is projected;

FIG. 4 is an enlarged view of the projector and the projected display of the mask of FIG. 3;

FIG. 5 is a view of the fold-down LCD display and lens assembly attached to an eye-protecting oxygen mask; and

FIG. 6 shows an alternative emergency heads up display system according to the invention.

### DESCRIPTION

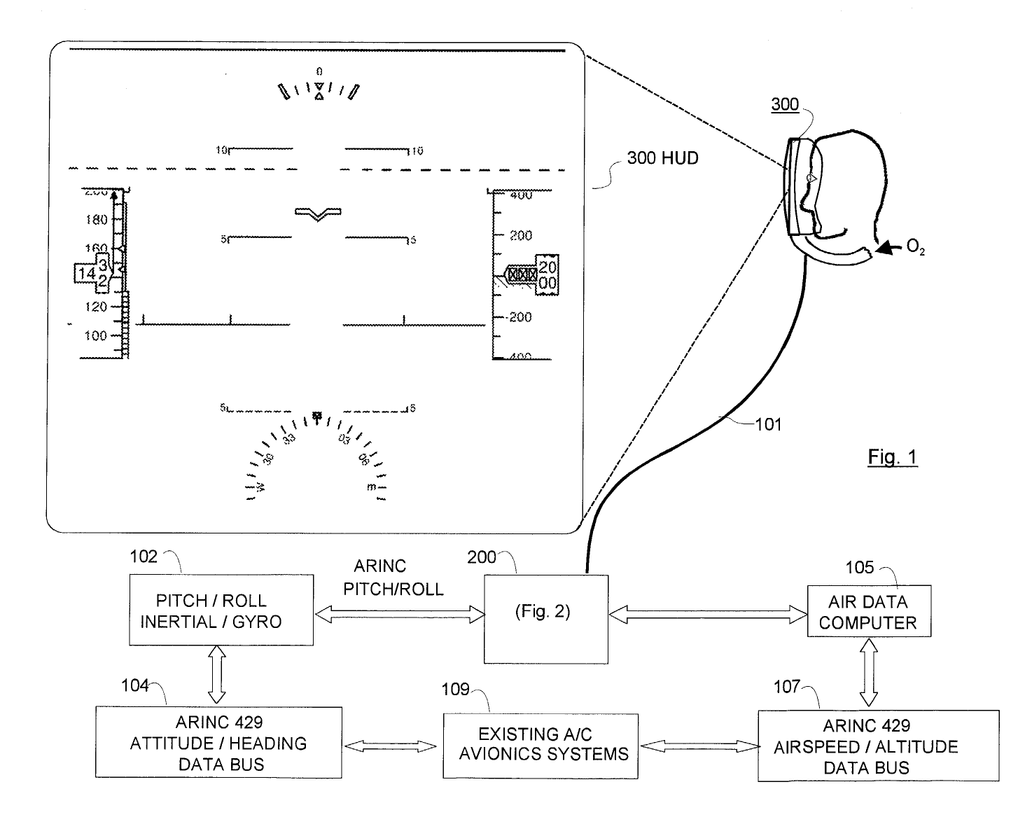

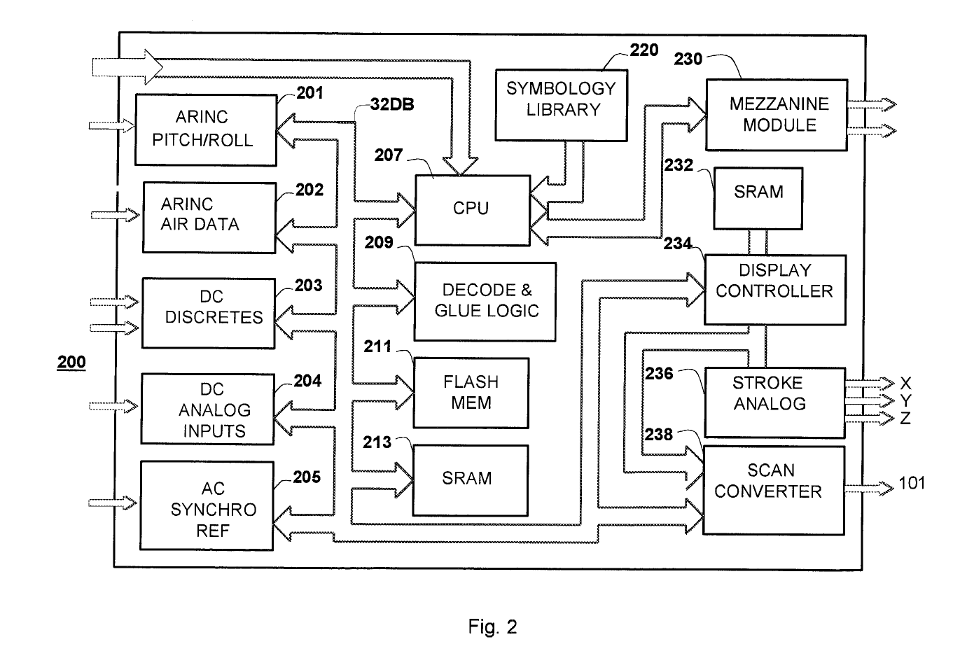

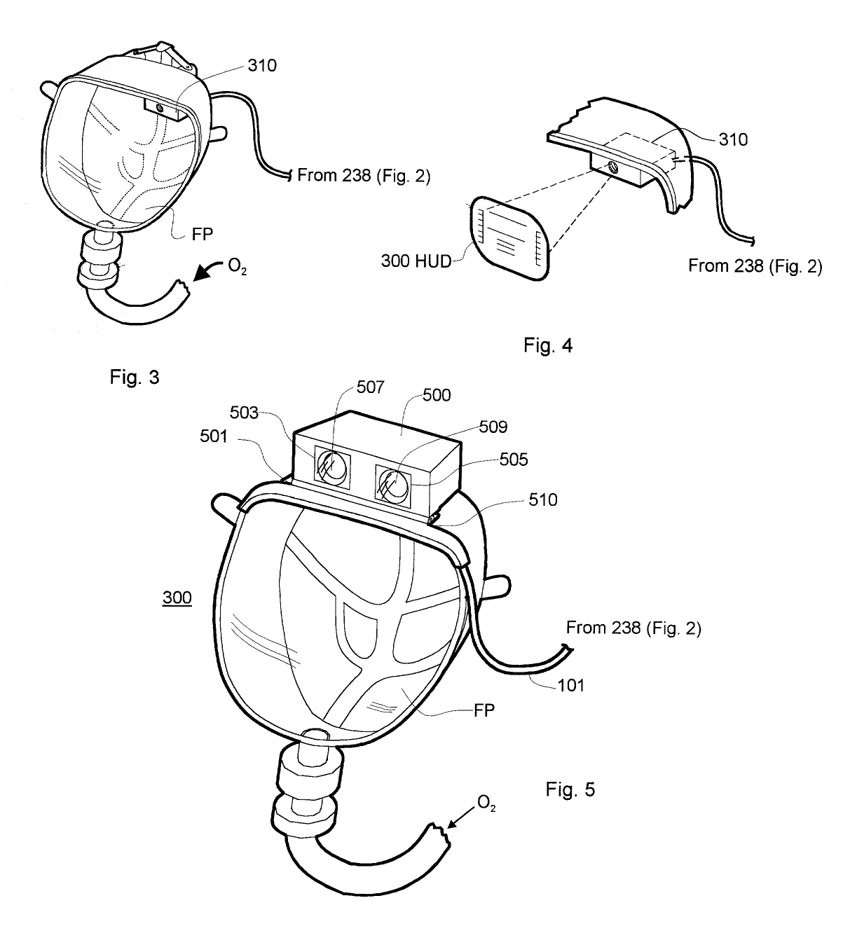

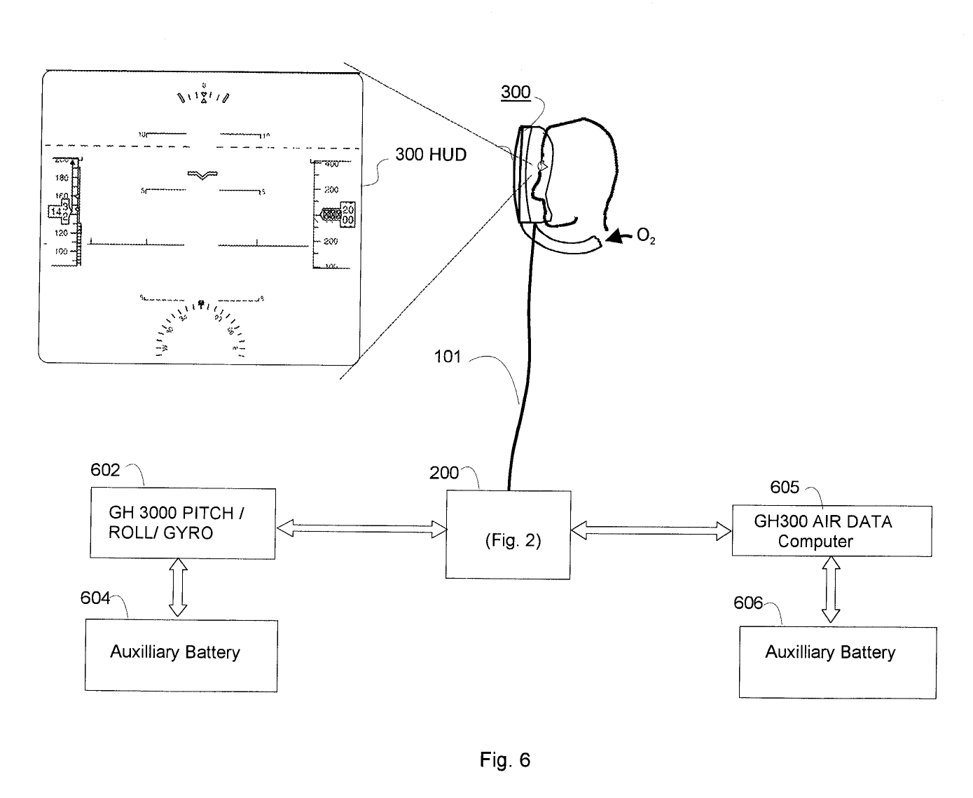

A conventional emergency oxygen mask, such as those manufactured by Scott Aviation, typically connect into the aircraft's oxygen supply port for use in emergency situations. In accordance with the invention, an emergency heads-up display is incorporated in a new mask 300, FIG. 1, which has a faceplate FP that covers and protects the entire face, especially the eyes of the wearer. Advantageously, the heads up display 300HUD may be provided either by an optical projection unit 310, shown in detail in FIG. 4, which projects the critical flight data onto face plate FP, or by a fold down device 500, FIG. 5, that is attached to the upper part of mask 300 and which is viewable through face plate FP. Face plate FP advantageously may be coated to provide a holographic, monochrome display of computer graphics representation of flight critical data for pilot interpretation and actions. Video data is provided to projection unit 301 or to fold down display unit 500 over wire harness 101 which connects to DPIO unit 200, FIG. 2. Display 300HD advantageously presents a blue and brown color for sky and earth respectively and digital data is presented in white. The Projected Display, on the Special Coated oxygen mask lens, is a monochrome holographic presentation that is light green in color.

In accordance with the invention, DPIO unit 200 receives existing commercial aircraft Attitude (Pitch and Roll), Heading, and Air Data (Altitude and Airspeed) from either ARINC Analog or ARINC Digital attitude and directional gyros/inertial data reference systems 102. This flight critical data is normally provided to the flight crew on flight deck displays (not shown) for interpretation to control the aircraft. Similarly, existing aircraft air data computer 105 provides aircraft ARINC air data (airspeed and altitude) to air data busses 107 that feed the existing flight deck instruments and the DPIO unit 200 in accordance with the invention.

DPIO 200 decodes and processes input data from aircraft sources such as aerospace standards ARINC 407, ARINC 429, ARINC 561, ARINC 575, ARINC 629, and Military Standard 1553 and contains video drivers to output video data that meets standards such as RS-170, RGB, VGA, NTSC, Raster Scan, and XY monochrome scans. Unit 200 is powered from the existing aircraft 28 Volt DC power distribution system or, optionally, by an independent battery. All data bus inputs are the sources for aircraft Attitude, Heading, Airspeed, and Altitude.

Input ports 201, 202 provide buffering and data processing to interface the DPIO internal 32 bit data bus 32DB to ARINC 407, ARINC 429, ARINC 561, ARINC 575, ARINC 629, and Military Standard 1553 data. Data bus 32DB interfaces with internal DPIO integrated circuits for calculations, rate processing, and symbology for display. DC Discrete Input integrated circuit 203 interfaces the logic lines from the aircraft either at a DC ground (aircraft airframe) classified as a “LOW” signal potential or at a fixed 5-30 Volt DC positive logic above ground classified as a “HIGH” signal potential. The discrete data is converted to digital data for placement on to DPIO internal bus 32DB. Analog inputs 204 are the same as DC discretes 203 except that these lines permit the positive DC Voltage to be variable from 5 to 30 Volts. The variable DC or Voltage data is converted to digital data for placement on to DPIO bus 32DB. These lines provide various aircraft system status information so that the DPIO can change processing states when required. AC Synchro 205 is in effect similar to item 204 above except that it is AC as opposed to the DC associated with item 204. The variable AC data is converted to digital data for placement on to DPIO bus 32DB. These lines provide various aircraft system status information so that the DPIO can change processing states when required. CPU 207 is the Central Processing Unit responsible for DPIO bus control, data distribution, mathematical calculations, built in test functions, record keeping, data conversions, memory control and storage, symbology control, library and table references, video control, status recognition, and configuration control. Decode and Glue logic circuits 209 hold software that is programmed for data recognition, verification, and enable/inhibit logic used to control valid data on the DPIO 32 bit data bus. 211—Flash Memory 211 is programmable non-volatile memory that hold DPIO configuration data. SRAM 213 is standard high speed volatile Random Access Memory. Symbology library integrated circuits 220 contain the software load that defines the symbology parameters for purposes of display. Display symbology includes aircraft Attitude, Heading, Airspeed, and Altitude. The library also dictates the look or appearance of the symbology on heads up display 300HD. Mezzanine Module 230 is a plug in mini circuit card that contains the Integrated circuits to process the input of Military Standard 1553 data busses as described in item 201. SRAM 232 a reliability duplicate for item 213 described above. Display Controller integrated circuits 234 process and organize the video data for conversion. It coordinates symbology with data rates and colors to be processed by the DPIO Video drivers such as the Stroke Analog Output or the Scan Converter 236. Stroke Analog integrated circuit 236 is a video driver for the projection display unit 310. Similar to a television tube, stroke converter 236 processes monochrome signals, containing the aircraft data and represented as symbology, for projection onto mask display 300HD. The stroke converter sweeps the aircraft data and symbology electronically for a display sweep at a rate fast enough for visual. Scan converter integrated circuit 238 performs a similar task as item 236, above, except the video driver is for fold-down display 500 which utilizes NTSC, RS-170, RGB, and VGA.

Oxygen Mask Lens Optical Proiection Assembly (FIGS. 3, 4)

The face plate FP of oxygen mask lens assembly 300 will advantageously be coated to reflect a holographic image that is projected from a small 9 mm projection device located inside the upper area of the mask.

Typical specifications:

a) Display: Monochrome Trans-missive Holographic

b) Contrast Ratio: 80:1

c) Brightness: 30 Foot Lamberts

f) Interface: NTSC, PAL, RS-170, VGA, RGB, XY Monochrome

g) Temperature: Operating Range −10 deg. C. to +70 Deg. C.

Fold Down Lens Assembly (FIG. 5)

Fold-down lens assembly 500 is hinged at 501 to the upper part of the face mask 300. Assembly 500 includes two adjustable lenses 503, 505 that house two color LCDs 507, 509, one for each eye. Adjustable lenses 503, 505 provide magnification to yield the equivalent of a 17″ computer display. Assembly 500 can be swung down for use or flipped back up for unobstructed vision through face place FP of the mask. view. When the fold-down lens assembly 500 is swung down, a microswitch 510 adjacent to hinge 501 and the terminus of cable 101 applies power to LCDs 507, 509 display for immediate display of aircraft attitude, heading and air-data. The LCD display advantageously employs blue and brown color for sky and earth, respectively, while digital data will be presented in white. However, colors are variable depending on customer requirements.

Exemplary Specifications:

a) Display: LCD 800×220 total color pixels−horizontal tv lines=400

b) Contrast Ratio: 200:1

c) Signal Input: NTSC, RS-170, PAL, VGA, and RGB

d) Interface: Video/BNC Connector

e) Power Source: 9-28 VDC

f) Power Consumption: 1.5-3 Watts (brightness dependent)

g) Interpupillary Range: 52-72 mm

h) Temperature Operating Range: −10 Deg. C. to +70 Deg. C.

i) Depressurization Tolerance to 40,000 feet

Referring to FIG. 6, an alternative embodiment is shown for use with such aircraft as still have the older analog based navigation, attitude reference, and air-data systems installed. In these cases, an FM certified BF Goodrich Aerospace GH-3000 attitude, heading, and air-data reference system is available to be installed to provide the required ARINC bus data. Accordingly, connections will be made between the GH-3000 system and the DPIO. The GH-3000 system is comprised of two (2) small units that easily installs into the existing aircraft. Two advantages of having the GH-3000 installed, is that it is also a back-up reference system for the existing Primary and Secondary flight critical data reference systems adding more system safety integrity to any aircraft, and provides for an auxiliary battery electrical power source. If the GH-3000 is installed, the aircraft pitot static system shall be connected to the GH-3000 air data computer. Also, if the auxiliary battery 604 is installed, power wiring will installed between the battery and DPIO 200. GH-3000 Attitude and Heading reference gyros 602 provide dedicated aircraft attitude (Pitch, Roll) and Heading to DPIO 200. GH-3000 ARINC Air Data Computer 605 provides dedicated aircraft Airspeed and Altitude to DPIO 200. Direct Current Power source 606 provides emergency electrical power in the event of normal aircraft power shut down to keep flight critical data on the Head-up Display attached to the Oxygen Mask.

What has been described is deemed to be illustrative of the principles of the invention. Further and other modifications will be apparent to those skilled in the art and may be made without, however, departing from the spirit and scope of the invention.

What is claimed is:

1. An emergency data display unit for use in aircraft having ARINC data busses for supplementing instrument panel display under conditions when the visibility of the instrument panel is impaired, comprising:
an eye-protecting oxygen mask having a transparent, sealed eye protecting visor;
a video unit mounted on said mask for displaying flight critical data images as a heads up display visible to the wearer of said mask;
an ARINC data buss interface unit for translating digital data from said ARINC busses to said video projection unit; said interface being operable upon the flow of oxygen to said mask.

2. An emergency data display unit according to claim 1 wherein said video unit is hinged to said mask so as to be folded down in front of said visor.

3. An emergency data display unit according to claim 1 wherein said video unit is mounted inside said mask to project said flight critical data upon said visor.

4. An emergency data display unit according to claim 2 further including a microswitch for energizing said video unit when said video unit is folded down in front of said visor.
